(19) United States
(12) Patent Application Publication
(10) Pub. No.: US 2022/0208158 A1
(43) Pub. Date: Jun. 30, 2022

(54) MUSICAL INSTRUMENT DIGITAL INTERFACE DEVICE

(71) Applicant: Max Friedman, St. Cloud, MN (US)

(72) Inventor: Max Friedman, St. Cloud, MN (US)

(21) Appl. No.: 17/565,852

(22) Filed: Dec. 30, 2021

Related U.S. Application Data
(60) Provisional application No. 63/132,946, filed on Dec. 31, 2020.

(51) Int. Cl. G10H 1/00; G10H 1/34

(52) U.S. Cl. CPC G10H 1/0066; G10H 2220/251; G10H 1/34; G10H 1/0008

(57) ABSTRACT

A musical instrument digital interface (MIDI) device includes a base that houses electronic circuitry. The base has a top portion with a top surface and a bottom portion configured to contact a surface when in use. A plurality of buttons are arranged on the top surface of the top portion of the base and in electronic communication with the electronic circuitry. The plurality of buttons each have a unique MIDI note number and are arranged in a pattern to facilitate visualization of intervals. An output device is configured to communicate with an external computing device.

### CROSS-REFERENCE TO RELATED APPLICATIONS

This application claims the benefit of U.S. Provisional Patent Application No. 63/132,946, filed Dec. 31, 2020, entitled, “MUSICAL INSTRUMENT DIGITAL INTERFACE DEVICE.” The disclosure of this priority application is hereby incorporated by reference in its entirety into the present application.

### BACKGROUND

Musical instruments can interface with computing devices using a musical instrument digital interface (MIDI). MIDI controllers can be used in combination with computing devices for music production. Keyboards are a common type of MIDI controller that use a piano keyboard layout. Other MIDI controllers include a menu of buttons that can be selected to produce different tones and effects. MIDI controllers typically have buttons or keys arranged based on the intervals of a piano. This includes a one dimensional diatonic line of pitches (C, D, E, F, G, A, B) with 5 pitches (C#, D#, F#, G#, A#) represented slightly above. This arrangement makes it difficult to visualize musical shapes of intervals.

It is against this background that the present disclosure is made. Techniques and improvements are provided herein.

### BRIEF DESCRIPTION OF THE DRAWINGS

FIG. 1 illustrates a top view of an example MIDI device.

FIG. 2 illustrates a side perspective view of the MIDI device of FIG. 1.

FIG. 3 is a schematic diagram illustrating the relationship of intervals with the arrangement of buttons of the MIDI device of FIG. 1.

FIG. 4 illustrates a schematic diagram of an example arrangement of MIDI notes on the buttons of the MIDI device of FIG. 1.

FIG. 5 is a schematic diagram illustrating . . . .

FIG. 6 illustrate a schematic diagram of another example arrangement of buttons of the MIDI device of FIG. 1.

FIG. 7 is a schematic diagram illustrating the arrangement of MIDI notes corresponding to the buttons in the arrangement of FIG. 6.

FIG. 8 illustrate a schematic diagram of another example arrangement of buttons of the MIDI device of FIG. 1.

FIG. 9 is a schematic diagram illustrating the arrangement of MIDI notes corresponding to the buttons in the arrangement of FIG. 8.

FIG. 10 is a schematic diagram illustrating another example arrangement of buttons of the MIDI device of FIG. 1.

FIG. 11 is a schematic diagram illustrating another example arrangement of buttons of the MIDI device of FIG. 1.

FIG. 12 illustrates a schematic diagram of an example computing device usable in conjunction with the MIDI device of FIG. 1.

### DETAILED DESCRIPTION

Described herein are MIDI input devices having buttons arranged in novel patterns to facilitate playing music. The MIDI devices operate to receive manual inputs from a user and transmit the inputs to a computing device to record the inputs. Generally, buttons are programmed to each have a unique MIDI tone or note. The arrangements of buttons described herein provide advantages over other MIDI devices because the arrangements allow a user to more easily visualize the musical shapes of intervals. Being able to visualize the relationships between notes enables a user to more easily learn to play music as well as learn to compose music.

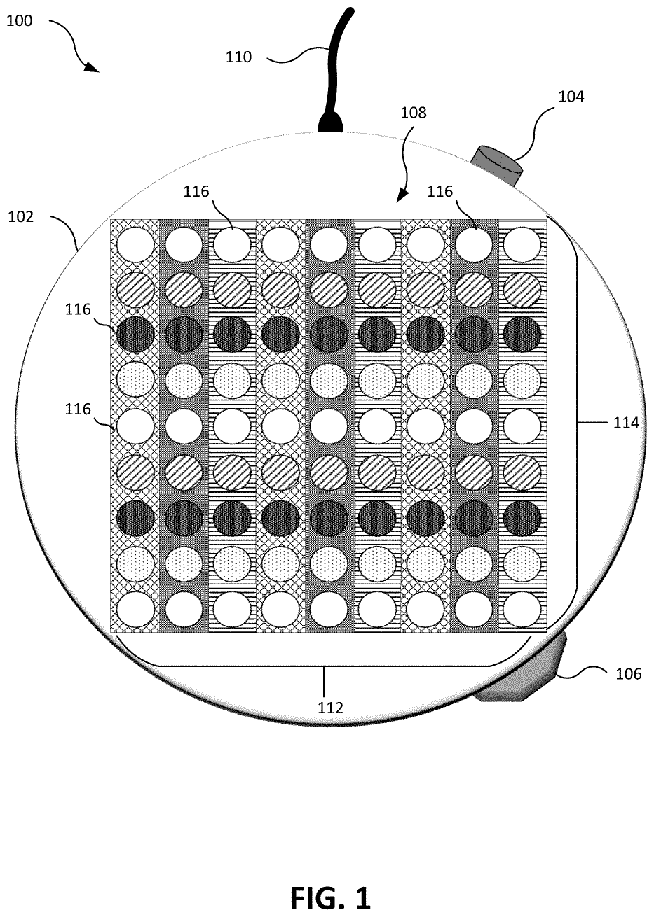

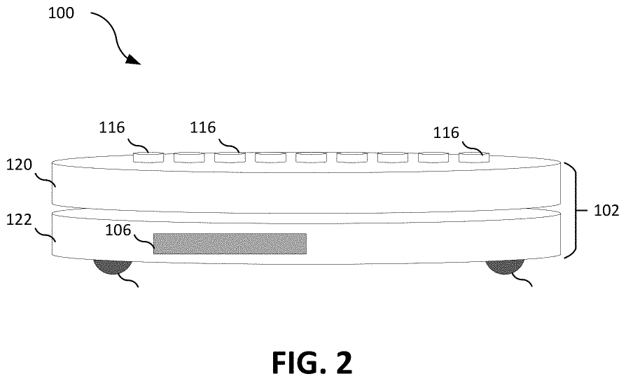

FIGS. 1 and 2 illustrate one example MIDI device 100 for controlling input of tones into a computing device for music production. The MIDI device 100 includes a base 102, power switch 104, an octave dial 106, and a gridboard 108. In some embodiments, the MIDI device 100 includes a communication cable 110 as shown in FIG. 1. In some embodiments, the MIDI device 100 includes a power cord (not shown). In other embodiments, the MIDI device 100 utilizes a portable power supply such as one or more batteries. In some embodiments, the MIDI device 100 is sized and configured to rest on a surface such as a desk or table. FIG. 1 shows a top view of the MIDI device 100. FIG. 2 shows a side perspective view of the MIDI device 100.

The base 102 operates to house the electronic circuitry of the MIDI device 100 and provide a surface upon which the gridboard 108 is affixed. In some embodiments, the base 102 is constructed from molded plastic. In some embodiments, the base 102 has a top portion 120 and a bottom portion 122, as illustrated in FIG. 2. The bottom portion 122 is configured to create a stable foundation for the MIDI device 100 to stably sit on a flat surface. In some embodiments, the bottom portion 122 has feet 124 to stabilize the MIDI device 100. The buttons 116 are arranged on the top portion 120. The top portion 120 can rotate relative to the bottom portion 122 such that the gridboard 108 rotates about a center axis. In some embodiments, the gridboard 108 is configured to rotate 360 degrees, but provides enough resistance to prevent the top portion 120 from spinning freely relative to the bottom portion 122. Rotation of the gridboard 108 allows for a user to position the MIDI device 100 at different angles to make playing patterns of notes more comfortable. In some embodiments, the base 102 has a circular shape. Other shapes and configurations are possible. For example, the base could have a square shape or a rectangular shape.

The power switch 104 controls the flow of power to the MIDI device. In some embodiments, the MIDI device 100 does not include a power switch 104 and powers on automatically when plugged into a power source.

The octave dial 106 operates to adjust the pitch of each button 116 by one or more octaves. The relationship between the pitches remains the same. In some embodiments, the octave dial 106 is a rotating wheel protruding from the side of the base 102 of the MIDI device 100. In some embodiments, another type of control operates to change the octave of the pitches on the board, such as one or more switches or buttons. In some embodiments, the octave dial 106 or other control is positioned at a different location on the board such as on a top surface of the top portion 120. Adjusting the octave dial 106 increases the ranges of pitches that can be produced by the MIDI device 100.

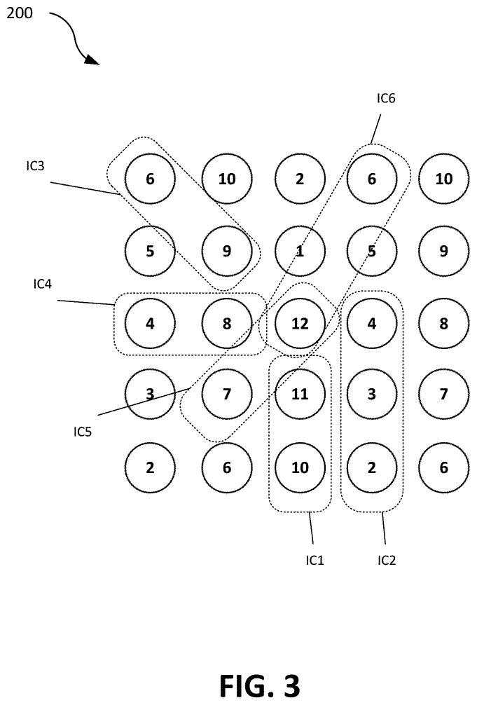

The gridboard 108 includes a plurality of buttons 116 arranged in rows 114 and columns 112. Each button corresponds to a different MIDI tone. In some embodiments, the buttons 116 are colored by rows 114 to distinguish between them. Additionally, the background of each column 112 has a different color. In the example of FIG. 1, the gridboard 108 has nine columns 112 and nine rows 114 of 81 buttons 116. In some embodiments, the background of the columns 112 rotates between three different colors. An example arrangement of MIDI tones is illustrated in FIG. 3. The color system alternates every 3 columns but also every 4 rows. The color system helps users track which pitches they are using on the grid system. Any pitch that is, for example, on an orange button will always be on an orange button, but what color column it lies on will rotate based on where it is positioned on the gridboard. For example, the columns 112 could be colored red, yellow, and blue. In some embodiments, the rows 114 of buttons 116 have colors rotating between four different colors. For example, the rows 114 of buttons 116 could be colored white, green, purple, and orange. Other arrangements and configurations of buttons are possible.

In some embodiments, the buttons 116 are backlit. In some embodiments, the buttons 116 light up when they are depressed. Each button 116 has a unique pitch on the gridboard 108. When depressed, the button 116 sends an electronic signal to an external computing device as input of a particular MIDI tone.

The communication cable 110 operates to provide an electronic connection between the MIDI device 110 and a computing device. In some embodiments, the communication cable 110 is a Universal Serial Bus (USB) cable. In some embodiments, the communication cable 110 is a serial port cable, a parallel port cable, or a Deutsches Institut für Normung (DIN) connector. In some embodiments, the communication cable 110 also provides power to the MIDI device 100.

FIG. 3 is a diagram 200 illustrating a condensed visual relationship between intervals using some of the arrangements described herein. In this diagram 200, pitches are labeled based on a 12 note scale (Mod 12). Music can be understood as shapes that exist in Mod 12 space. Mod 12 refers to a 12 note scale. These shapes are made out of intervals (differences in pitch between two notes or tones). Combinations of interval types characterize the sound of a musical shape.

Various intervals are labeled in FIG. 3, illustrating the various visual relationships between the pitches. 25 different pitches are labeled with a number from 1 to 12, representing notes of a scale. However, unlike most conventional MIDI devices that use a one dimensional diatonic line of pitches, the pitches in the diagram 200 are arranged in a grid so that multiple intervals can be easily accessed within a small space.

Musical shapes are more distinguishable and ergonomic when they are transferred from a diatonic line system (like a piano, woodwind, or the grand-staff) to a 2 dimensional grid system (like a guitar, bass or violin). This is because A) a broader range of intervals can be easily viewed within a more confined area making them easier to identify, and because B) pitch space is represented consistently.

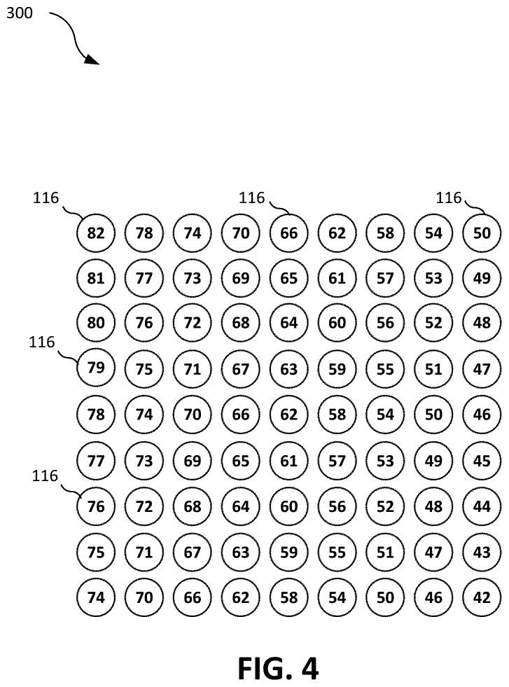

In the device described herein, each unit along the Y-axis changes by 1 step. Each unit along the X-axis changes by 4 steps. This arrangement creates one of the most compact grids for a mod 12 system possible, as illustrated in FIGS. 3 and 4. Of the two most compact arrangements possible, this one supports the most total instrument range. IC1 represents a difference of one step between pitches. Here, 10 and 11 are circled in a vertical arrangement. Throughout the grid, the pitches located directly above and below one another are a half step apart in a 12 note scale. IC2 represents a two step difference (two pitches apart, such as 2 and 4 as shown). 6 and 9 are circled with the label for IC3, representing a three step difference between pitches. IC4, IC5, IC6 represent a difference of 4, 5, and 6 steps between pitches respectively.

Each ‘interval class’ (interval and its inverse) falls on a convenient slope with the exception of IC 6 (an interval with no inverse). This arrangement presents each interval type within an easily identifiable and physically accessible arrangement without requiring a lot of movement (for either the eyeball or the hand), thus making it incredibly easy to rapidly identify and perform the variety of musical shapes constructed from the variety of interval types found in Western music.

FIG. 4 is a schematic diagram illustrating an arrangement 300 of buttons 116 for the MIDI device 100. The arrangement 300 of pitches has been optimized on a grid based on the interval arrangement described in FIG. 3. Each button 116 has a unique MIDI number corresponding to a particular note or pitch. The center button 116 is assigned to MIDI number 62. Each button 116 above the center button is assigned to a consecutively higher MIDI number (63, 64, 65, etc.) while each button 116 below the center button is assigned to a consecutively lower MIDI number (61, 60, 59, etc.). Each button 116 to the right of the center button is assigned to a lower MIDI number by four (58, 54, etc.). Each button 116 to the left of the center button is assigned to a higher MIDI number by four (66, 70, etc.). Note that different MIDI numbers could be used in the gridboard 108 as long as they are arranged with the same interval relationships. For example, the center button 116 could be MIDI number 43 or MIDI number 118.

In the arrangement of FIG. 4, each of the 12 chromatic pitches can be played in at-least 3 octaves at any given time. A chromatic scale can be played with 4 fingers moving horizontally down the device, without adjusting its position vertically.

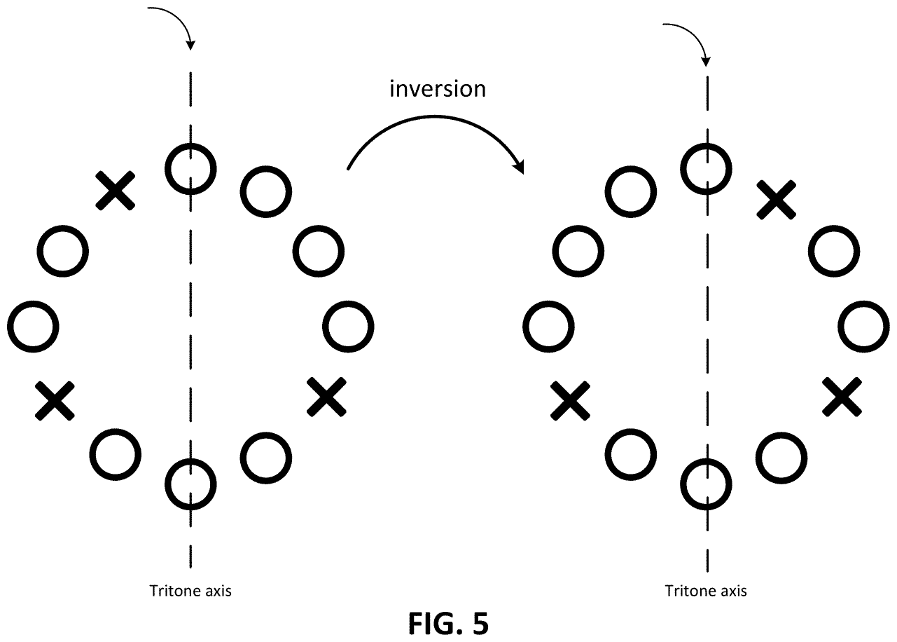

FIG. 5 is a schematic diagram illustrating another arrangement of notes that can be used with the MIDI devices. This arrangement more effectively illustrates functional inversions. In this example, the circles and x's represent 12 different notes arranged in a circle. The circles represent notes that are not played while the x's represent notes that are played. The circle can be flipped on the “tritone axis” to show how the arrangement of notes would appear when inverted.

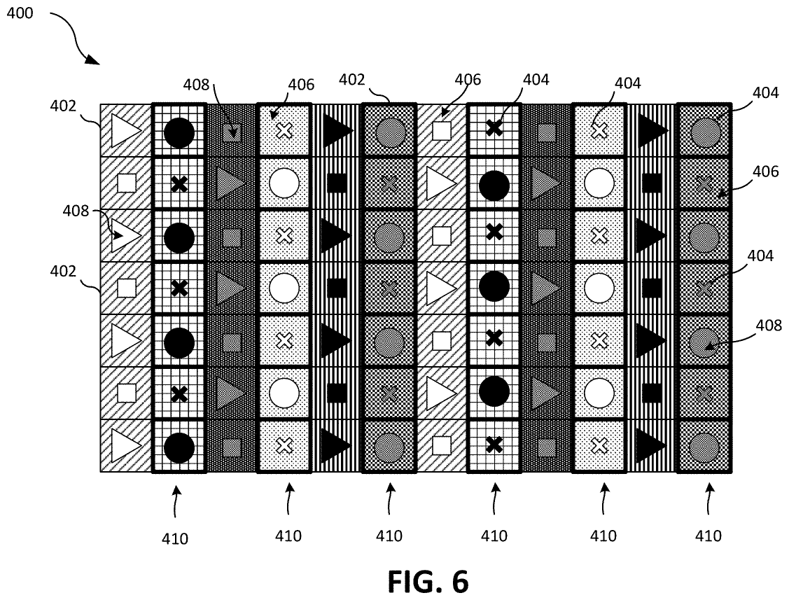

FIG. 6 is a schematic diagram illustrating another example arrangement 400 of buttons 402 for the MIDI device 100. In this example, the buttons 402 are arranged in 12 columns and 7 rows. Each button 402 has a symbol 404. In this example, four different symbols 404 are repeated in patterns on the buttons 402. In particular, as you move from left to right along a row, the symbols 404 are in a repeating pattern of triangle, circle, square, x. The pattern of symbols 404 alternates every other row such that each column includes alternating triangles and squares or alternating circles and x's.

The buttons 402 each have a particular background color 406 selected from 6 options. Each button also features a shaded symbol 404 that is one of three colors or shades. As shown in FIG. 6, each column of buttons 402 shares the same background color 406. The six different background colors 406 of buttons 402 are repeated twice throughout the 12 columns of buttons 402. In one example, the columns of buttons 402 could be colored: red, yellow, blue, orange, purple, green, red, yellow, blue, orange, purple, green. Similarly, in this example the shaded symbols 404 are the same symbol color 408 within each column. There are three different symbol colors 408 rotating four times through the columns for shaded symbols 404. In one example, the columns of shaded symbols 404 could be colored: white, black, gray, white, black, gray, etc. Note that other combinations of colors, shading, and shapes could be used to similarly represent 12 notes.

The result of the different symbols 404, background colors 406, and symbol colors 408 is that multiple different combinations are formed on each of the buttons 402. Additionally, every other column has its buttons 402 outlined. These columns of outlined buttons 410 add an additional dimension. Each unique combination of background color 406, symbol color 408, and outlining represents a different tone or note in a 12-note chromatic scale. The particular arrangement of the combinations is designed to provide compact ease of use for touching particular intervals of notes.

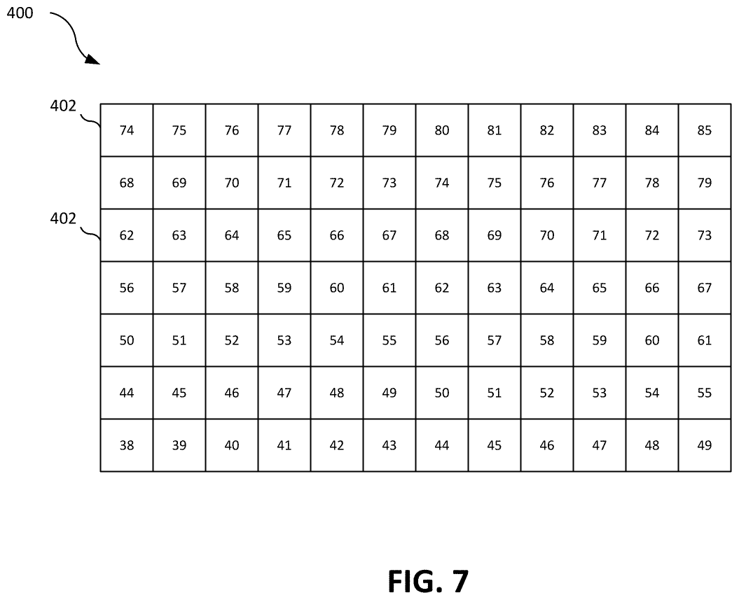

One particular arrangement of notes is illustrated in FIG. 7 by labeling each button 402 with a MIDI number. Here, as you move from left or right within a row the values increase or decrease by one. As you move up or down within a column, the values increase or decrease by 6.

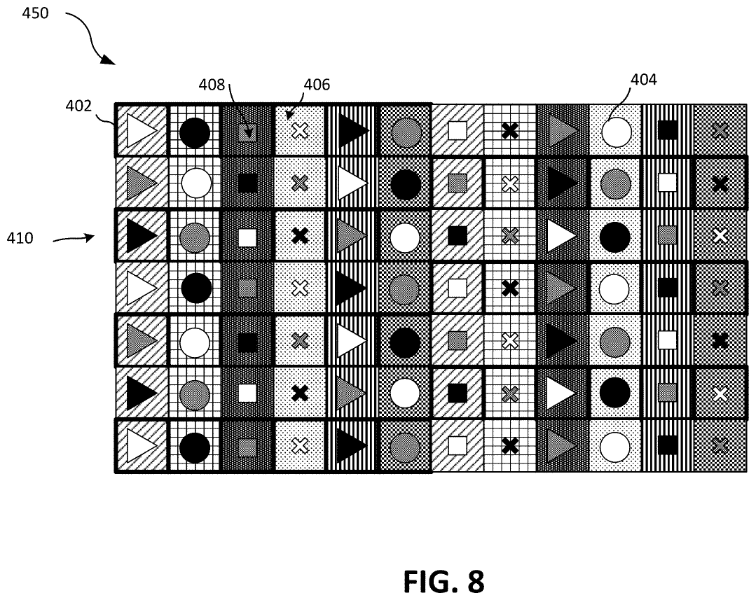

FIG. 8 a schematic diagram illustrating an alternative arrangement 450 of buttons 402 for the MIDI device 100. Again, there are twelve columns and seven rows of buttons 402. The buttons 402 each include the shaded symbols 404, background colors 406, symbol colors 408, and outlining as described in FIG. 6. However, the arrangement of the different combinations is different. In this example, the same four symbols 404 are repeated in patterns on the buttons 402, moving left to right. However, in this example, the same pattern of symbols 404 is found in each row such that each column includes all of the same symbol 404.

Again, columns of buttons share the same color selected from 6 options. Each button also features a shaded symbol 404 that is one of three colors or shades. Here, instead of the symbols 404 having a consistent shade throughout a column, as you move right/left or up/down the shades rotate between the three options. Additionally, some of the buttons 402 are outlined 410 to provide further emphasis. Instead of every other column being outlined (as in FIG. 6), every other row is outlined, but the opposite rows are outlined on the right half of the diagram.

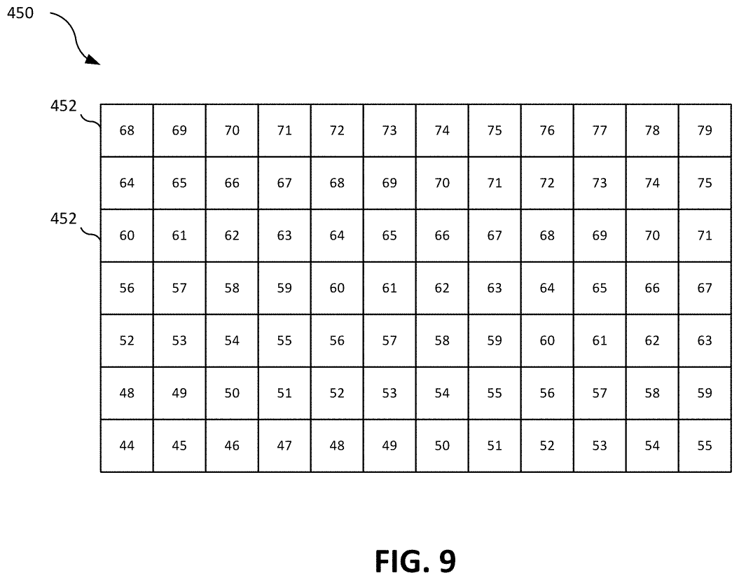

An arrangement of notes corresponding to the diagram of FIG. 8 is illustrated in FIG. 9 by labeling each button 452 with a MIDI number. Here, as you move from left or right within a row the values increase or decrease by one. As you move up or down within a column, the values increase or decrease by 4.

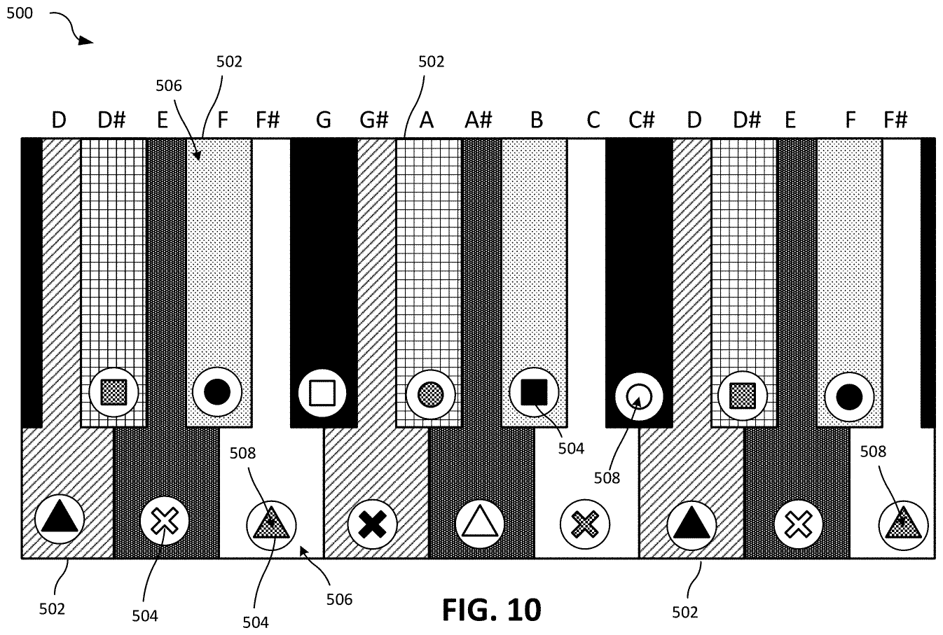

FIG. 10 is a schematic diagram of another alternative arrangement 500 of buttons 502 for a different embodiment of the MIDI device 100. In this example, the buttons 502 are arranged with alternating flat and raised keys, similar to a traditional piano keyboard. Different combinations of background colors 506, symbols 504, and symbol colors 508 are used to signify one of twelve notes. The particular combinations are similar to those described above for the other arrangements of buttons. In this example, note names are provided above each key corresponding with notes in a 12-note scale.

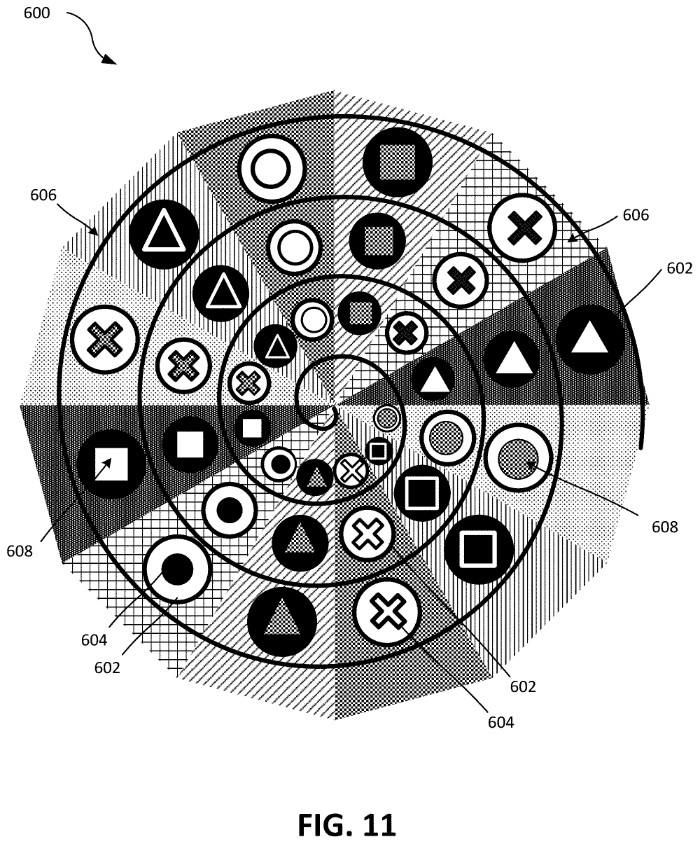

FIG. 11 is a schematic diagram of another alternative arrangement of 600 of buttons 602 for a different embodiment of the MIDI device 100. In this example, the buttons 602 are arranged in a spiral. Each of the buttons 602 has a unique pitch and is arranged such that the buttons 602 increase in pitch by one as they move from the center to the outer portion of the spiral and buttons in radial alignment are one octave apart. Again, different combinations of background colors 606, symbols 604, symbol colors 608, and button colors 610 are used to signify one of twelve notes. Here the colored backgrounds 606 have one of six rotating colors and the buttons 610 alternate between two colors. Each button 602 has one or four rotating symbols 604 that each have one of three rotating symbol colors 608.

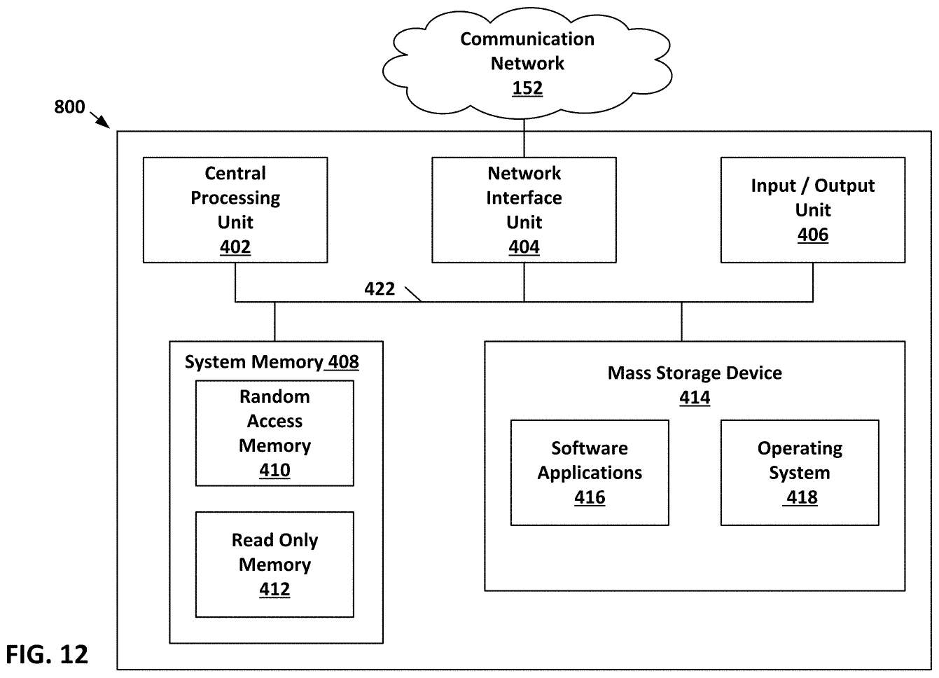

FIG. 12 is a block diagram illustrating an example of the physical components of a computing device 400. The computing device 400 could operate in conjunction with the MIDI device 100 to produce music.

In the example shown in FIG. 12, the computing device 400 includes at least one central processing unit (“CPU”) 402, a system memory 408, and a system bus 422 that couples the system memory 408 to the CPU 402. The system memory 408 includes a random access memory (“RAM”) 410 and a read-only memory (“ROM”) 412. A basic input/output system that contains the basic routines that help to transfer information between elements within the computing device 400, such as during startup, is stored in the ROM 412. The computing system 400 further includes a mass storage device 414. The mass storage device 414 is able to store software instructions and data.

The mass storage device 414 is connected to the CPU 402 through a mass storage controller (not shown) connected to the system bus 422. The mass storage device 414 and its associated computer-readable storage media provide non-volatile, non-transitory data storage for the computing device 400. Although the description of computer-readable storage media contained herein refers to a mass storage device, such as a hard disk or solid state disk, it should be appreciated by those skilled in the art that computer-readable data storage media can include any available tangible, physical device or article of manufacture from which the CPU 402 can read data and/or instructions. In certain examples, the computer-readable storage media includes entirely non-transitory media.

Computer-readable storage media include volatile and non-volatile, removable and non-removable media implemented in any method or technology for storage of information such as computer-readable software instructions, data structures, program modules or other data. Example types of computer-readable data storage media include, but are not limited to, RAM, ROM, EPROM, EEPROM, flash memory or other solid state memory technology, CD-ROMs, digital versatile discs (“DVDs”), other optical storage media, magnetic cassettes, magnetic tape, magnetic disk storage or other magnetic storage devices, or any other medium which can be used to store the desired information and which can be accessed by the computing device 400.

According to some examples, the computing device 400 can operate in a networked environment using logical connections to remote network devices through a network 152, such as a wireless network, the Internet, or another type of network. The computing device 400 may connect to the network 152 through a network interface unit 404 connected to the system bus 422. It should be appreciated that the network interface unit 404 may also be utilized to connect to other types of networks and remote computing systems. The computing device 400 also includes an input/output controller 406 for receiving and processing input from a number of other devices, including a touch user interface display screen, or another type of input device. Similarly, the input/output controller 406 may provide output to a touch user interface display screen or other type of output device.

As mentioned briefly above, the mass storage device 414 and the RAM 410 of the computing device 400 can store software instructions and data. The software instructions include an operating system 418 suitable for controlling the operation of the computing device 400. The mass storage device 414 and/or the RAM 410 also store software instructions, that when executed by the CPU 402, cause the computing device 400 to provide functionality for music production.

Although various embodiments and examples are described herein, those of ordinary skill in the art will understand that many modifications may be made thereto within the scope of the present disclosure. Accordingly, it is not intended that the scope of the disclosure in any way be limited by the examples provided.

What is claimed is:

1. A musical instrument digital interface (MIDI) device comprising:
a base housing electronic circuitry, the base having a top portion with a top surface and a bottom portion configured to contact a surface when in use;
a plurality of buttons arranged on the top surface of the top portion of the base and in electronic communication with the electronic circuitry, the plurality of buttons each having a unique MIDI note number and being arranged in a pattern to facilitate visualization of intervals; and
an output device configured to communicate with an external computing device.

2. The MIDI device of claim 1, further comprising an octave control in electronic communication with the electronic circuitry of the base, the octave control configured to raise or lower the pitch of each button by one or more octaves.

3. The MIDI device of claim 1, wherein the buttons have visual indicators corresponding to particular notes in a 12 note scale, the visual indicators comprising one or more of shapes, symbols, colors, patterns, and outlines.

4. The MIDI device of claim 1, wherein the buttons are arranged in a grid having rows and columns such that the MIDI note number of the buttons increase or decrease by one between each row and the MIDI note number of the buttons increase or decrease by four between each column.

5. The MIDI device of claim 1, wherein the buttons are arranged in 12 columns and 12 rows.

6. The MIDI device of claim 1, wherein the buttons are arranged in 12 columns and 7 rows such that the MIDI note number of the buttons increase or decrease by 6 between each row and the MIDI note number of the buttons increase or decrease by one between each column.

7. The MIDI device of claim 6, wherein each button has one of six rotating background colors, one of four rotating symbols, and one of three rotating symbol shades.

8. The MIDI device of claim 7, wherein each button within a column has the same background color and symbol color, where each background repeats every six columns and each symbol color repeats every three columns.

9. The MIDI device of claim 1, wherein the buttons are arranged in 12 columns and 7 rows such that the MIDI note number of the buttons increase or decrease by 4 between each row and the MIDI note number of the buttons increase or decrease by one between each column.

10. The MIDI device of claim 9, wherein each button has one of six rotating background colors, one of four rotating symbols, and one of three rotating symbol shades.

11. The MIDI device of claim 10, wherein each button within a column has the same background color and the background color repeats every six columns, and wherein each button within a column has the same symbol shape and the symbol shape repeats every four columns.

12. The MIDI device of claim 1, wherein the buttons are arranged in a keyboard of larger flat keys alternating with smaller raised keys that increase by one MIDI note when moving from left to right.

13. The MIDI device of claim 12, wherein each key is one of six colors with one of four symbols displayed on the key, wherein the symbols have one of three colors.

14. The MIDI device of claim 1, wherein the buttons are arranged in a spiral such that the MIDI number of each button increases when moving from center outward.

15. The MIDI device of claim 14, wherein the spiral has 12 shaded regions comprising six rotating colors, the buttons have alternating colors, each button has one of four shapes, and the shapes have one of three colors.

16. A musical instrument digital interface (MIDI) device comprising:
a base housing electronic circuitry, the base having a top portion with a top surface and a bottom portion configured to contact a surface when in use, wherein the top portion and bottom portion are circular in shape and rotate about a central axis relative to one another;
a gridboard positioned on the top surface of the top portion of the base, the gridboard comprising a plurality of buttons in electric communication with the electronic circuitry and arranged in rows and columns, wherein each of the plurality of buttons has a unique pitch and is arranged such that the columns are spaced by intervals of four and the rows are spaced by intervals of one, and wherein the columns of buttons are laid over a colored backgrounds having first set of three different rotating colors, and wherein the rows of buttons are colored with a second set of three different rotating colors that are different from the first set of three different rotating colors;
an octave control in electronic communication with the electronic circuitry of the base, the octave control configured to raise or lower the pitch of each button on the gridboard by one or more octaves;
an output device configured to communicate with an external computing device.

17. A musical instrument digital interface (MIDI) device comprising:
a base housing electronic circuitry, the base having a top portion with a top surface and a bottom portion configured to contact a surface when in use, wherein the top portion and bottom portion are circular in shape and rotate about a central axis relative to one another;
a gridboard positioned on the top surface of the top portion of the base, the gridboard comprising a plurality of buttons in electric communication with the electronic circuitry and arranged in 7 rows and 12 columns, wherein each of the plurality of buttons has a unique pitch and is arranged such that the columns are spaced by intervals of one and the rows are spaced by intervals of six, and wherein the columns of buttons are laid over a colored backgrounds having first set of six different rotating colors, and wherein each button has one of four symbols having one of three shades; and
an output device configured to communicate with an external computing device.

18. The MIDI device of claim 17, further comprising an octave control in electronic communication with the electronic circuitry of the base, the octave control configured to raise or lower the pitch of each button on the gridboard by one or more octaves.

19. A musical instrument digital interface (MIDI) device comprising:
a base housing electronic circuitry, the base having a top portion with a top surface and a bottom portion configured to contact a surface when in use, wherein the top portion and bottom portion are circular in shape and rotate about a central axis relative to one another;
a gridboard positioned on the top surface of the top portion of the base, the gridboard comprising a plurality of buttons in electric communication with the electronic circuitry and arranged in 7 rows and 12 columns, wherein each of the plurality of buttons has a unique pitch and is arranged such that the columns are spaced by intervals of one and the rows are spaced by intervals of four, and wherein the columns of buttons are laid over colored backgrounds having six different rotating colors, and wherein each button has one of four symbols having one of three shades; and
an output device configured to communicate with an external computing device.

20. The MIDI device of claim 19, further comprising an octave control in electronic communication with the electronic circuitry of the base, the octave control configured to raise or lower the pitch of each button on the gridboard by one or more octaves.
